(19) United States
(12) Patent Application Publication
(10) Pub. No.: US 2004/0245852 A1
(43) Pub. Date: Dec. 9, 2004

(54) Target wheel cover that emulates motorcycle wheel finish

(76) Inventors: Manuel A. Quintana, Chihuahua (MX); Steven Douglas Thomson, El Paso, TX (US)

Correspondence Address: PATRICK M. GRIFFIN, DELPHI TECHNOLOGIES, INC., Legal Staff, Mail Code: 480-410-202, P.O. Box 5052, Troy, MI, 48007-5052, US

(21) Appl. No.: 10/441,411

(22) Filed: May 20, 2003

(51) Int. Cl. B60T 8/32

(52) U.S. Cl. 303/137

(57) ABSTRACT

A target wheel cover adapted for use in a motorcycle having an anti-locking braking system with a target wheel disposed on a hub of a wheel of the motorcycle, the target wheel cover comprising a cover being configured to be disposed over the target wheel wherein the cover has an exterior finish that matches the wheel of the motorcycle.

### TECHNICAL FIELD

The present disclosure relates to anti-locking braking systems (ABS) and in particular anti-locking braking systems for motorcycles.

### BACKGROUND

Anti-locking braking systems (ABS) have nearly become standard features on many vehicles. In general, the rotation or rotational frequency of at least one vehicle wheel is compared to other wheels of the vehicle or to a database of known values wherein further rotational movement of the measured wheel is modified by applying a signal to a vehicle controller wherein the operation of the braking system is controlled partially by the vehicle controller in order to prevent an un-desirable situation such as wheel locking.

In the motorcycle arts other types of wheel measurement such as angular displacement with respect to a road surface are also measured. Regardless of the type of anti-locking braking system or wheel monitoring system employed or used, one common aspect is that the rotation of the vehicle's wheel must be measured for providing a reading indicative of the wheel and use in the monitoring system.

Thus, a sensor or sensing device must be positioned on the rotating wheel in order to provide the necessary information to a controller of the ABS system. In addition, and as part of the allure of owning a motorcycle there is a particular customer satisfaction or desire to own a motorcycle having multiple chrome parts that shine or sparkle in the presence of light. One of the parts containing a chrome or chrome like appearance is the wheel or rim of the motorcycle however, this is the same location as the sensor or sensing device of the ABS system, which does not have an exterior appearance that matches the rest of the vehicle wheel.

Therefore, the motorcycle can be either made with an ABS system having a sensor that does not match the appearance of the motorcycle wheel or the motorcycle can be manufactured without the ABS system, which is un-desirable.

### SUMMARY

A target wheel cover adapted for use in a motorcycle having an anti-locking braking system with a target wheel disposed on a hub of a wheel of the motorcycle, comprising: a cover being configured to be disposed over the target wheel wherein the cover has an exterior finish that matches the wheel of the motorcycle.

A method of providing an anti-locking braking system (ABS) in a motorcycle having at least one wheel, comprising: positioning a magnetic target wheel on the wheel; covering the magnetic target wheel with a cover having an inner surface and an outer surface, wherein the outer surface emulates the surface of the wheel; and locating a sensor adapted to sense movement of the magnetic target wheel in a position proximate to the cover.

An anti-locking braking system for a motorcycle, having at least one wheel, comprising: a target wheel configured to be disposed on a portion of the wheel, the target wheel having magnetic qualities; a sensor adapted to sense the magnetic qualities of said target wheel and provide a signal indicative of the sensed magnetic qualities; and a cover configured to be disposed over the target wheel, the cover having an inner and outer surface, the outer surface being similar to the wheel of the motorcycle, wherein the cover disguises the target wheel when the target wheel and the cover are positioned on the wheel.

### BRIEF DESCRIPTION OF THE DRAWINGS

The present invention will now be described, by way of example, with reference to the accompanying drawings, in which:

FIG. 1 is a side elevational view of a motorcycle;

FIG. 2 is a perspective view of a wheel of a motorcycle with a braking system;

FIG. 3 is a perspective view of a wheel of a motorcycle;

FIG. 4 is a perspective view of a wheel of a motorcycle with a target wheel for an anti-locking brake system;

FIG. 5 is a perspective view of a wheel of a motorcycle with a cover of the present disclosure disposed over the target wheel;

FIG. 6 is a side elevational view of a portion of a motorcycle wheel without a target wheel;

FIG. 7 is a side elevational view of a portion of a motorcycle wheel with a target wheel or an anti-locking brake system and a cover of the present disclosure disposed over the target wheel;

FIG. 8 is a perspective view of a receiving area or underside of a cover of the present disclosure with a target wheel disposed therein;

FIG. 9 is a perspective view of a cover of the present disclosure and a target wheel;

FIG. 10 is a perspective view of a hub of a motorcycle wheel with a target wheel;

FIG. 11 is a perspective view of a finished surface of a hub of a motorcycle wheel without a target wheel;

FIG. 12 is a perspective view of a hub of a motorcycle wheel with a target wheel and a cover of the present disclosure;

FIG. 13 is a side view of a hub of a motorcycle wheel with a target wheel and a sensor of an anti-locking braking system;

FIG. 14 is an enlarged view of a portion of FIG. 13;

FIG. 15 is a perspective view of a sensor of an anti-locking braking system; and

FIG. 16 is a perspective view of a bracket of an anti-locking braking system.

### DESCRIPTION OF THE EMBODIMENTS

Disclosed herein is a cover or means for covering a target wheel of an anti-locking braking system (ABS) of a motorcycle, wherein the cover has an exterior surface or finish that emulates the exterior or surface of the portion of the motorcycle where the target wheel is applied. Therefore, the cover of the present disclosure provides a means for covering a target wheel of an anti-locking braking system (ABS) of a motorcycle such that the motorcycle wheel resembles a wheel that has no such system.

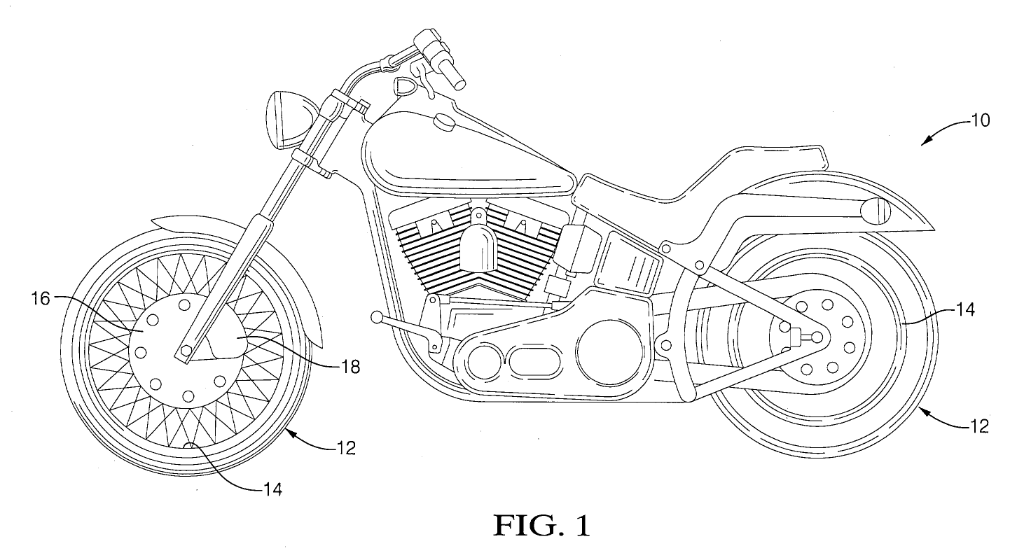

Referring now to FIG. 1, a motorcycle 10 is illustrated. Motorcycle 10 comprises a pair of wheels 12 each having a rim 14. In the illustrated motorcycle the front wheel or rim has a brake rotor disc 16 adapted to interact with a brake calliper 18. As is known in the art the brake calliper comprises a means for applying a frictional or stopping force to the surface of brake rotor disc 16, which is secured to and rotates with the wheel.

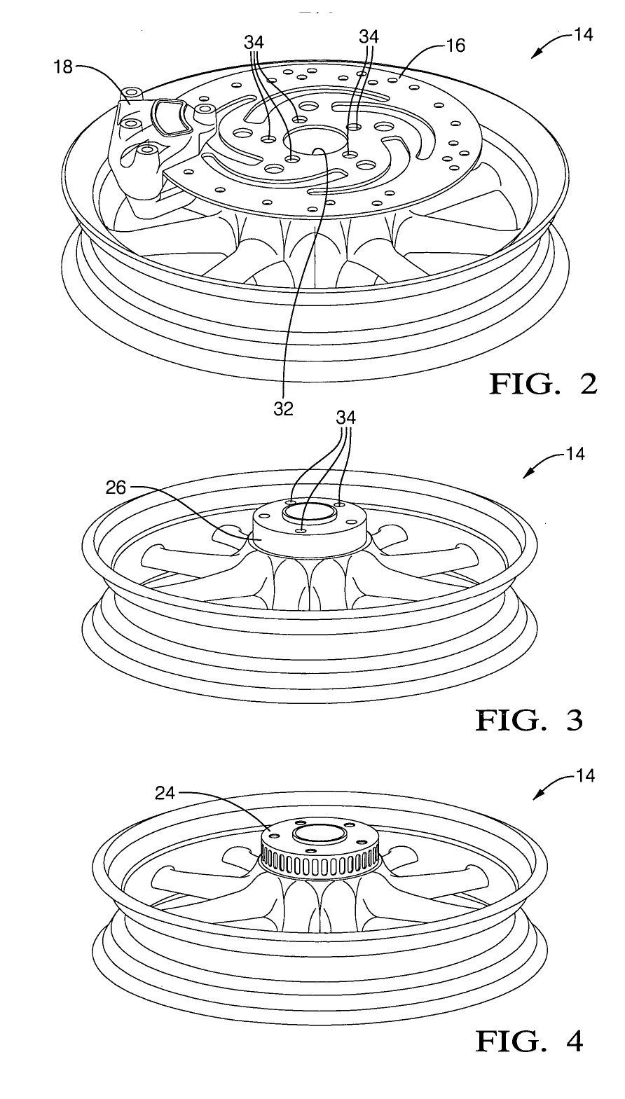

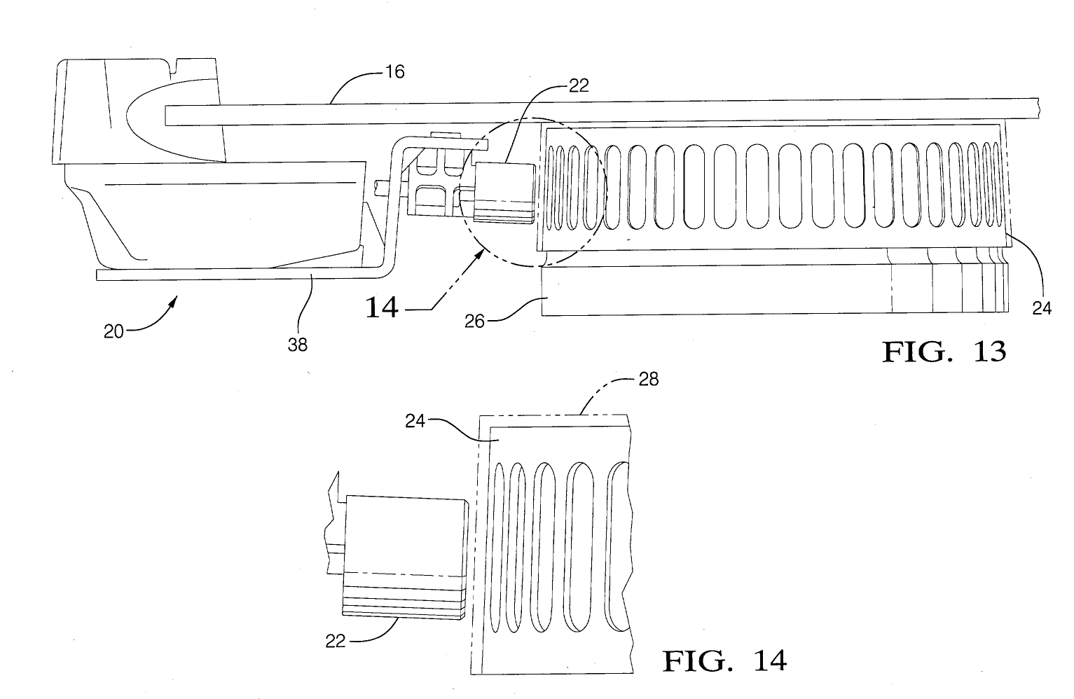

FIG. 2 also illustrates a motorcycle wheel 14 with a brake rotor disc 16 and brake calliper 18. In order to provide a signal of the wheel rotational dynamics to a controller of an ABS system (not shown) a sensor assembly 20 (FIG. 13) is disposed behind the brake rotor disc. The sensor assembly comprises a sensor 22 positioned to detect the rotation or rotational speed of an item secured to the wheel such that the item rotates with the wheel and the sensor remains stationary. Therefore, and as is known in the related arts of anti-locking braking systems, the sensor will provide a signal indicative of the rotating wheel to the ABS controller wherein the signal is utilized in accordance with ABS technologies.

In the disclosed embodiment of FIGS. 2-14, a target wheel 24 is disposed on a portion or hub 26 of wheel 14. In the embodiment discussed herein target wheel 24 is constructed out of a ferro-magnetic material or alternatively is a magnetic material and is configured to be placed over hub 26. In addition, sensor 22 comprises a sensor, such as a Hall type sensor that is capable of sensing the revolving or alternating magnetic fields caused by the flux interruption of the target wheel. Other types of sensors include but are not limited to the following: MR sensors; magnetic sensor or magneto resistive sensor. Of course, the present disclosure is not intended to be limited to the specific types of ABS systems and components disclosed herein. The cover of the present disclosure is intended for use with any type of sensing means comprising a sensor and item whose position or rotation is sensed.

In an exemplary embodiment cover 28 is manufactured out of a non-magnetic material such as aluminium. Thus, the cover will not interfere with the magnetic field interrupted by the target wheel as well as providing an exterior surface or finish that matches the exterior surface of wheel 14. This is particularly the case when both the wheel 14 and cover 28 are manufactured from aluminium or aluminium alloys thus, the exterior or show surfaces will match. Therefore, the cover essentially provides a disguise for the target wheel, which typically comprises an item that does not match or detracts from the aesthetic qualities of the wheel. Of course, other equivalent materials for the cover are considered to be within the scope of the present disclosure.

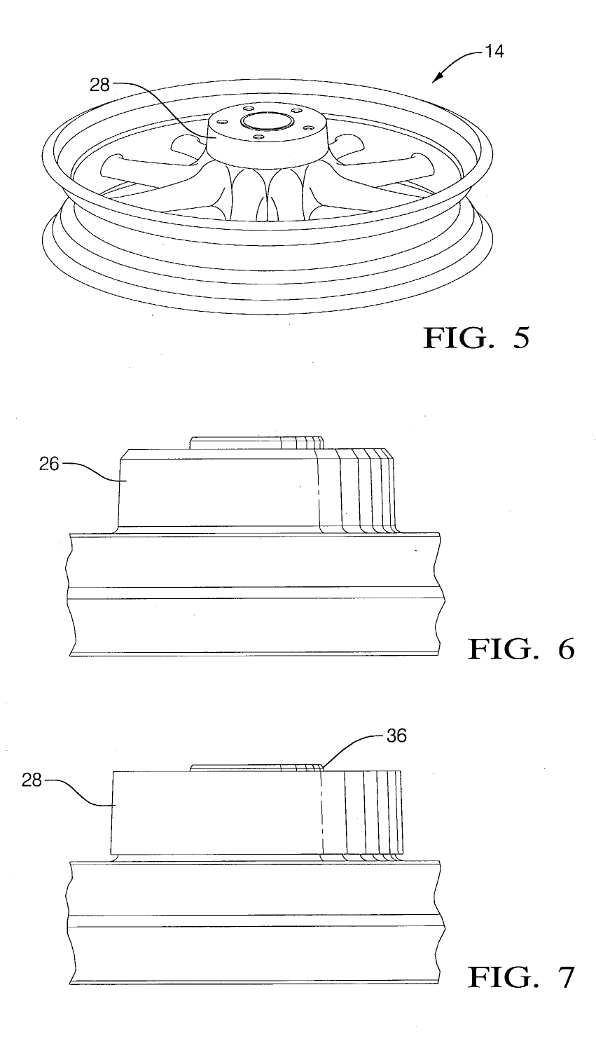

FIG. 3 illustrates a motorcycle wheel 14 having no target wheel disposed thereon. FIG. 4 illustrates a motorcycle wheel 14 with a target wheel 24 disposed over a hub portion 26 of wheel 14. FIG. 5 illustrates a motorcycle wheel 14 with a cover 28 disposed over the target wheel. In accordance with an exemplary embodiment cover 28 encases or shrouds target wheel 24. In addition, cover 28 has an exterior surface that emulates the exterior finish of wheel 14. Thus, the appearance of the wheel in FIG. 5 (having target wheel and cover) resembles the wheel of FIG. 2 (no target wheel or cover). Accordingly, cover 28 of the present disclosure allows wheel 14 to be equipped with an ABS system while still maintaining the stylistic appearance shown in FIG. 3 (e.g., a wheel without an ABS system).

Referring also to FIGS. 6 and 7 side views of the hub of the motorcycle wheel with (FIG. 7) and without (FIG. 6) cover 28 are illustrated. As can be seen from the Figures the profiles of the wheel with and without the cover are very similar. Thus, a target wheel is capable of being disposed on the hub of the wheel and then covered by cover 28 in order to provide the stylistic appearance shown in FIG. 3 (e.g., a wheel without an ABS system).

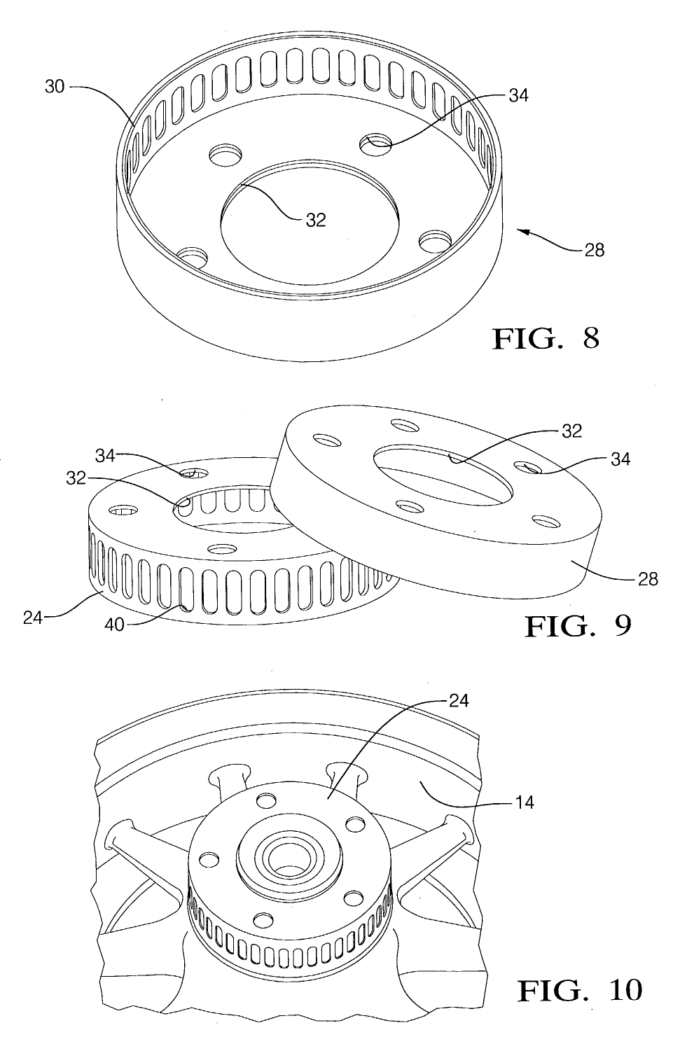

FIG. 8 illustrates an inner area 30 of cover 28 with target wheel 24 in place. Area or receiving area 30 is configured to receive target wheel 24 therein. Thus, target wheel 24 can be either positioned first on hub 26 before cover 28 or target wheel 24 can be inserted within cover 28 and the same is then secured to the hub. In addition, and referring now to FIGS. 8-10 and in an exemplary embodiment of the present disclosure both cover 28 and target wheel 24 each have a central opening 32 as well as a plurality of mounting openings 34. The position of openings 32 and 34 allows target wheel 24 and cover 28 to be secured to hub 26 in a quick and efficient manner suitable for mass or assembly line production.

Opening 32 is configured to allow a portion 36 (FIG. 7) of hub 26 to pass therethrough while openings 34 align with complimentary openings in the hub to allow securement thereto through the use of a plurality of securing members such as bolts. It is also noted that the openings (32 and 34) of the hub, the target wheel and the cover align with openings of the brake rotor disc 16 (FIG. 2). Accordingly, target wheel 24 can be placed or press fitted onto hub 26 and then cover 28 is then secured on top of the target wheel or alternatively the target wheel can be inserted into the cover first and then the cover is placed over the hub of the wheel.

Referring now to FIGS. 9 and 10 the target wheel and cover of an exemplary embodiment of the present disclosure are illustrated. As illustrated target wheel 24 has a plurality of openings 40 that provide gaps in the magnetic material being sensed by sensor 22. Accordingly, as the target wheel rotates the revolving interrupted magnetic field is sensed and the sensor is capable of providing wheel dynamics such as speed to a controller of the ABS system.

As shown in FIG. 10 the target wheel disposed on the hub of the wheel without a cover provides a distinct contrast to the surfaces of the motorcycle wheel.

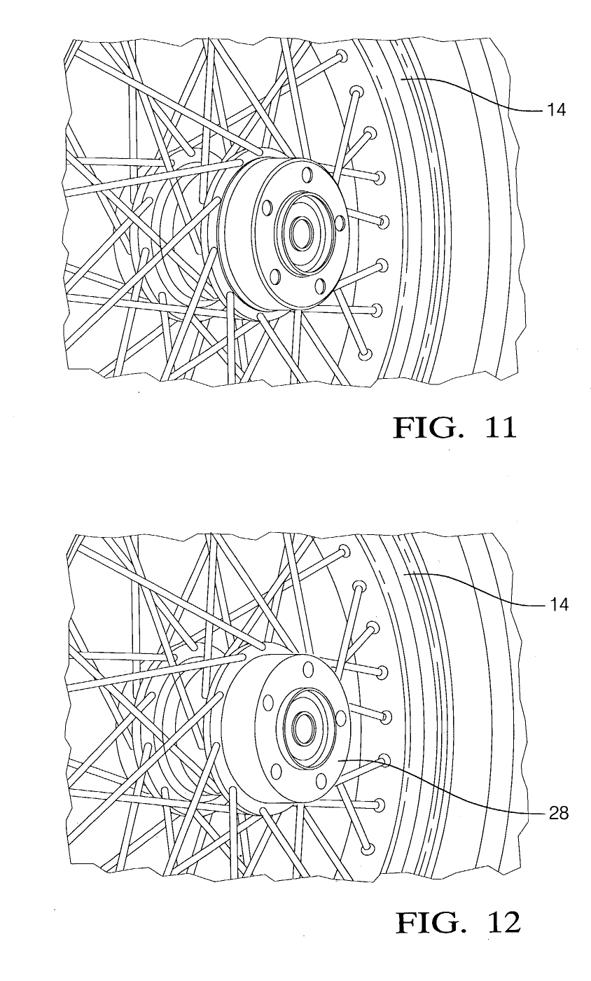

FIGS. 11 and 12 also illustrate a hub of a motorcycle wheel with (FIG. 12) and without (FIG. 11) cover 28. As can be seen from the Figures the profiles of the wheel with and without the cover are very similar. Thus, a target wheel is capable of being disposed on the hub of the wheel and then covered by cover 28 in order to provide the stylistic appearance shown in FIG. 11 (e.g., a wheel without an ABS system).

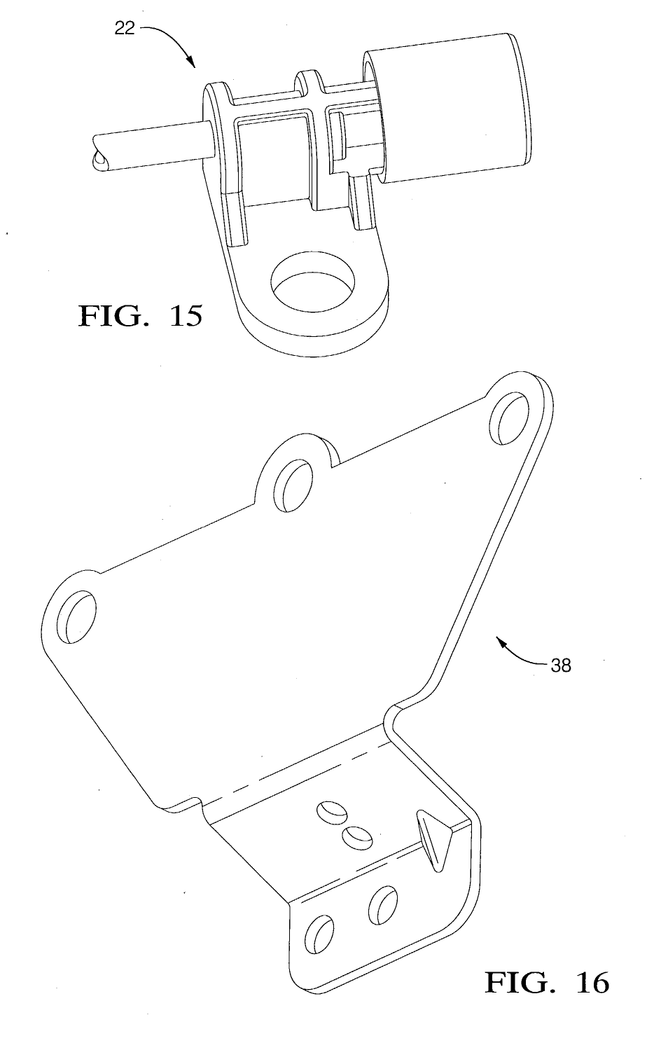

Referring now to FIGS. 13 and 14 the positioning of sensor 22 with respect to target wheel 24 is illustrated. Here sensor 22 (See also FIG. 15) is mounted to a bracket 38 (see also FIG. 16), which is secured to a portion of the brake calliper disposed behind the brake rotor disc. Of course other points of securement are contemplated in accordance with the present disclosure, for example the sensor may be secured to the fork tube of the motorcycle. As illustrated in FIG. 14 the target wheel is disposed behind cover 28 while sensor 22 is positioned close enough to record the rotation of hub 26 and target wheel 28 disposed thereon. For example the end portion of the sensor can be disposed at 1-2 millimetres from the exterior surface of the cover. Of course, and as applications require the distance between the sensor and the cover may be greater or less than the dimensions mentioned above.

In an exemplary embodiment target wheel 24 is ferro-magnetic material, which as it rotates it interrupts a magnetic field that is sensed by the sensor and cover 28 is non-magnetic material such as aluminium or other equivalent material that has a decorative surface applied thereon that matches the looks or surface of the motorcycle wheel.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the present disclosure not be limited to the particular embodiment disclosed as the best mode contemplated for carrying out this invention, but that the invention will include all embodiments falling within the scope of the appended claims. Furthermore, no element, component, or method step in the present disclosure is intended to be dedicated to the public regardless of whether the element, component, or method step is explicitly recited in the claims.

1. A target wheel cover adapted for use in a motorcycle having an anti-locking braking system with a target wheel disposed on a hub of a wheel of the motorcycle, comprising:
a cover being configured to be disposed over the target wheel wherein said cover has an exterior finish that matches the wheel of the motorcycle wherein said cover has a plurality of openings being configured and positioned to align with openings on the target wheel and openings on the hub of the motorcycle wheel.

2. The target wheel cover as in claim 1, wherein said cover is made out of a non-magnetic material.

3. (Cancelled)

4. (Cancelled)

5. The target wheel cover as in claim 2, wherein said cover is made out of aluminium.

6. (Cancelled)

7. (Cancelled)

8. An anti-locking braking system for a motorcycle, having at least one wheel, comprising:
a target wheel configured to be disposed on a portion of the wheel, said target wheel having magnetic qualities;
a sensor adapted to sense the magnetic qualities of said target wheel and provide a signal indicative of the sensed magnetic qualities;
a cover configured to be disposed over said target wheel, said cover having an inner and outer surface, said outer surface being similar to the wheel of the motorcycle, wherein said cover disguises said target wheel when said target wheel and said cover are positioned on the wheel; and
a plurality of openings in said cover being configured and positioned to align with openings on the target wheel, and openings on the hub of the motorcycle wheel.

9. The anti-locking braking system as in claim 8, wherein said cover is made out of a non-magnetic material.

10. The anti-locking braking system as in claim 9, wherein said sensor is a Hall type sensor.

11. (Cancelled)

12. (Cancelled)

13. The anti-locking braking system as in claim 8, further comprising a brake rotor disc and a brake calliper wherein the sensor is secured to the brake calliper at a position between the wheel and the brake rotor disc.

14. The anti-locking braking system as in claim 8, further comprising a brake rotor disc wherein the sensor is positioned between the wheel and the brake rotor disc.

15. (Cancelled)
